(19) United States
(12) Patent Application Publication
(10) Pub. No.: US 2026/0298438 A1
(43) Pub. Date: Oct. 1, 2026

(54) Collimated optical source

(71) Applicant: Lumos Technology Co., Ltd., Taipei (TW)

(72) Inventor: Chih-Yi Yang, Taipei (TW)

(21) Appl. No.: 19/449,508

(22) Filed: Jan. 15, 2026

Related U.S. Application Data
(60) Provisional application No. 63/754,460, filed on Feb. 5, 2025.

(51) Int. Cl. F21V 5/00; F21V 29/74

(52) U.S. Cl. CPC F21V 5/007; F21V 29/74

(57) ABSTRACT

A collimated lighting source includes: a base; first solid-state lighting assemblies and second solid-state lighting assemblies, where the first solid-state lighting assemblies each comprise a first unit cell and a fluorescent portion; a column of semi-cylindrical lenses arranged along the single row with their counts corresponding to total counts of the first and second solid-state light emitting modules; a semi-cylindrical elongated lens disposed on the base and oriented perpendicular to the major axis of each of the semi-cylindrical lenses; a photomask configured to: when the second solid-state lighting assemblies are enabled to emit light beams, mask the light beams from entering the fluorescent portions of the first solid-state lighting assemblies, and when the first solid-state lighting assemblies are enabled to emit light beams, expose the first solid-state lighting assemblies.

### FIELD

The present disclosure relates to a lighting source for inspection, and more particularly relates to a collimated lighting source for inspection with semi-cylindrical lenses.

### BACKGROUND

Cleanrooms are commonly seen in sectors such as food manufacturing, optoelectronics, semiconductor manufacturing, biochemical technology, biotechnology, precision machinery, pharmaceutical manufacturing, and hospital operating rooms. To improve the quality, yield, and reliability of a product or an experimental process, the cleanrooms are subjected to rigorous environmental controls in terms of temperature, humidity, and air quality; in addition, the counts of microparticles is also strictly limited.

Microparticles can be generally filtered out via a filter through a repeated air convection process in the cleanroom. However, certain special microparticles (such as cosmetic particles, electrostatically charged particles shed from gloves or clothing, and even dust adhering to sebum from human skin) exhibit some tackiness and therefore tend to adhere to a workbench surface. Some microparticles exhibit unduly high adhesive force attributed to their intrinsic electrostatic charge or the sebum they adhere to, such that they can hardly be removed from the surface even by a vacuum cleaner. If the microparticles adhering to an object's surface are removed by high-pressure air purging, they tend to disperse randomly, resulting in secondary contamination of the cleanroom.

On the other hand, for those microparticles barely visible to naked eyes, it is impossible to accurately determine their counts and locations, such that they cannot be effectively removed even by manual wiping. Due to their fineness, even with auxiliary illumination, the operator still cannot locate such microparticles or determine whether they have been completely removed, especially when the incident light striking the workbench at a highly oblique angle is intensely and directly reflected into the operator's eyes.

For semiconductor wafers and optical modules, the smoothness and flatness of their surfaces not only affect product yield in the manufacturing process but also affect product efficiency and reliability in subsequent use. Therefore, an automated optical inspection (AOI) system is generally used to detect presence of a defect. Since a smooth surface has a high reflectivity, if a lighting source for inspection is disposed directly above to illuminate a inspection object and an image capture device is also disposed directly above to capture an image of the surface thereof, the image of a defect tends to be completely obscured by the reflected light, rendering it unidentifiable Therefore, as shown in FIG. 1, the lighting source for inspection is disposed such that an incident beam 92 strikes a surface 90 of an inspection object at a low angle α from one side, and based on the law of reflection, the directly reflected beam 94 exits at the same low angle α from the opposite side, which does not enter the image-capturing range or the eyes of the observer 9, such that only the weak diffuse reflection from a defect 96 or dust, along with any potential fluorescence or phosphorescence, can be identified and analyzed by the image-capturing device.

To ensure the credibility of quantitative comparison for defect/dust analysis and recording, the incident beam emitted by the low-angle inspection lighting source shall exhibit no convergence or divergence within the covered area, which requires a collimated lighting source. The typical collimated lighting source is a laser, which, however, fails to provide a uniform light intensity over an illuminated surface of, for example, several square centimeters due to its unduly concentrated energy and very small illumination coverage. FIG. 2 shows an LED lighting source, which is currently most commonly used, where a die 82 is generally mounted on a circuit substrate 80, and a parabolic lens 84 disposed in the emission direction of the lighting source converts the divergent light field into parallel output beams.

However, parabolic lenses are difficult to grind and polish, resulting in low manufacturing yield and low production efficiency, which in turn leads to high costs, disadvantageous for the overall manufacturing cost. On the other hand, even if the LED die 82 is employed to redirect the light emitted from the LED die 82 into a collimated beam, non-uniform illuminance distribution still persists, where the energy is concentrated in the central region 86 and diminished in the edge region 88 of the light field. This uneven illuminance across the illuminated plane would produce an image with regions of nonuniform brightness which is also disadvantageous for observation, monitoring, or automated identification.

Therefore, the present disclosure is primarily directed to a collimated lighting source for inspection, which exhibits reduced manufacturing costs, higher product yield, improved production efficiency, and particularly, enhanced illuminance uniformity, thereby better satisfying requirements of practical optical inspection.

### SUMMARY

Hereinafter, the features and advantages of the present disclosure will be described in detail through exemplary embodiments, the contents of which suffice for those skilled in the art to understand and implement; moreover, based on the description, the scope, and the drawings of the disclosure, those skilled in the art may easily understand the objectives and advantages of the present disclosure.

A collimated lighting source for inspection is provided, comprising two groups semi-cylindrical lenses oriented perpendicular to each other such that the light beams emitted by the respective dies combine into a substantially square illumination pattern; when they are arranged in a single row, an elongated, substantially uniformly illuminated inspection range may be achieved.

A collimated lighting source for inspection is provided, which employs semi-cylindrical lenses for optical path modulation, thereby facilitating manufacturing, reducing costs, and achieving a yield far higher than that of parabolic lenses.

A collimated lighting source for inspection is provided, which employs two different solid-state lighting assemblies, where when one module emits light, the other module with a fluorescent portion is automatically masked from illumination, thereby preventing unintended interference from the fluorescent portion; this double-light-source independent illumination enables a more accurate, reliable inspection.

A collimated lighting source for inspection according to the present disclosure comprises: a base; a plurality of first solid-state lighting assemblies and a plurality of second solid-state lighting assemblies, the plurality of first solid-state lighting assemblies and the plurality of second solid-state lighting assemblies being alternatively arranged in a single row on the base, wherein the first solid-state lighting assemblies each comprise at least one first unit cell and one fluorescent portion illuminated by a light beam emitted by the first unit cell to emit fluorescence; a column of semi-cylindrical lenses arranged along the single row, counts of the semi-cylindrical lenses corresponding to total counts of the first and second solid-state light emitting modules, each of the semi-cylindrical lenses having a cylindrical, unidirectionally collimating, light-refracting outer edge extending along a major axis, the major axis being oriented perpendicular to the single row; a semi-cylindrical elongated lens disposed on the base and oriented perpendicular to the major axis of each of the semi-cylindrical lenses; at least one photomask configured to: when the second solid-state lighting assemblies are enabled to emit light beams, mask the light beams from entering the fluorescent portions of the first solid-state lighting assemblies, and when the first solid-state lighting assemblies are enabled to emit light beams, expose the first solid-state lighting assemblies.

The semi-cylindrical lenses may be made from a transparent material via extrusion or drawing; provided that a mold features a semi-side edge with a profile conforming to, for example, a parabolic curve, the transparent material can be extruded or drawn into an elongated semi-cylindrical shape matching the mold profile, which is then axially cut into semi-cylindrical lenses or semi-cylindrical elongated lenses of different lengths and heights along the axial direction according to desired dimensions. The manufacturing process is simple with a reduced cost; particularly, the lens profile can be easily tailored to meet optical configuration requirements, ensuring excellent and consistent quality. The optical configuration jointly constituted by the semi-cylindrical lenses crossed relative to each other can facilitate the light beams emitted by the solid-state lighting assemblies to be collimated into a substantially square, uniform illumination pattern for output; the uniform illumination facilitates low-angle light inspection. Moreover, due to provision of the photomask, the two different types of solid-state lighting assemblies may emit light flexibly while eliminating mutual interference therebetween; even if one of them is provided with a fluorescent portion, the fluorescent portion may be masked from being illuminated and thus prevented from photoluminescence when the other one is emitting light, thereby ensuring reliability of illumination for inspection.

### BRIEF DESCRIPTION OF THE DRAWINGS

FIG. 1 is a schematic diagram of low-angle inspection lighting source, illustrating a basic optical configuration for a low-angle illumination operation.

FIG. 2 is a stereoscopic diagram of a known lighting source comprising an array of LED modules equipped with corresponding parabolic lenses, illustrating an output light pattern achieved with the parabolic lenses.

FIG. 3 is a stereoscopic exploded view of a collimated lighting source according to a first exemplary embodiment of the present disclosure, illustrating configurations of first and second solid-state lighting assemblies, as well as optical configurations of a semi-cylindrical lens, a semi-cylindrical elongated lens, and a photomask.

FIGS. 4 and 5 are top views of the embodiment of FIG. 3, illustrating positions and operating modes of the photomask when the first and second solid-state lighting assemblies emit light for inspection, respectively.

FIG. 6 is a stereoscopic combination view of a collimated lighting source for inspection according to a second exemplary embodiment of the present disclosure.

FIG. 7 is a top view of the embodiment of FIG. 6, illustrating optical configurations of a semi-cylindrical lens, a semi-cylindrical elongated lens, and a photomask.

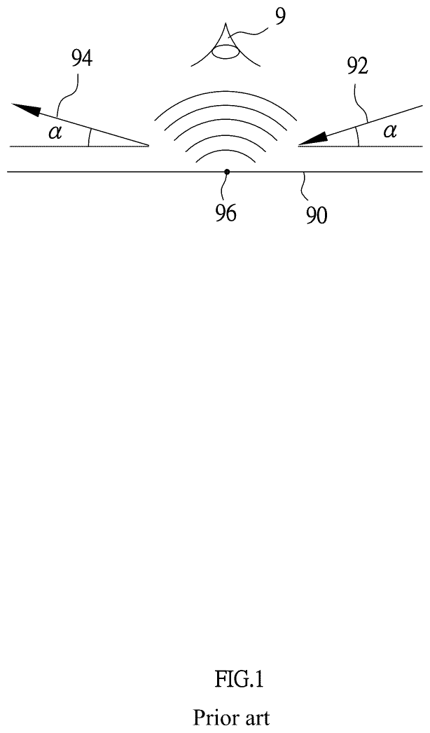

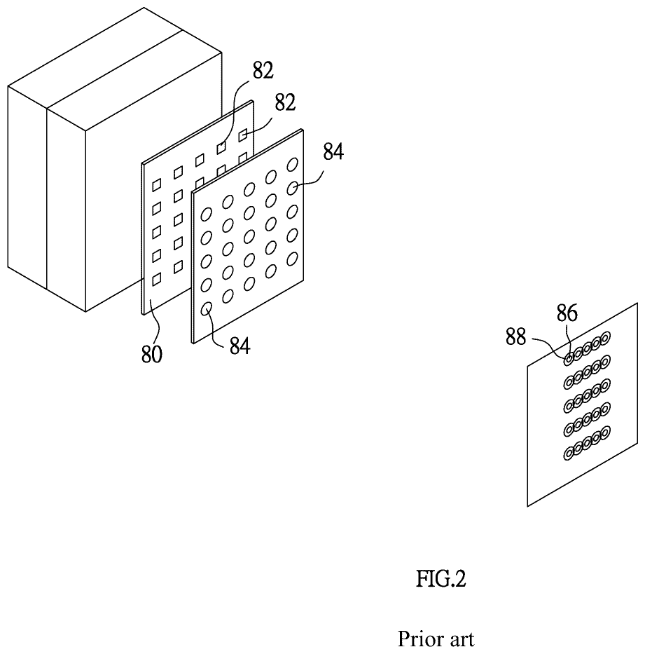

### DETAILED DESCRIPTION OF EMBODIMENTS

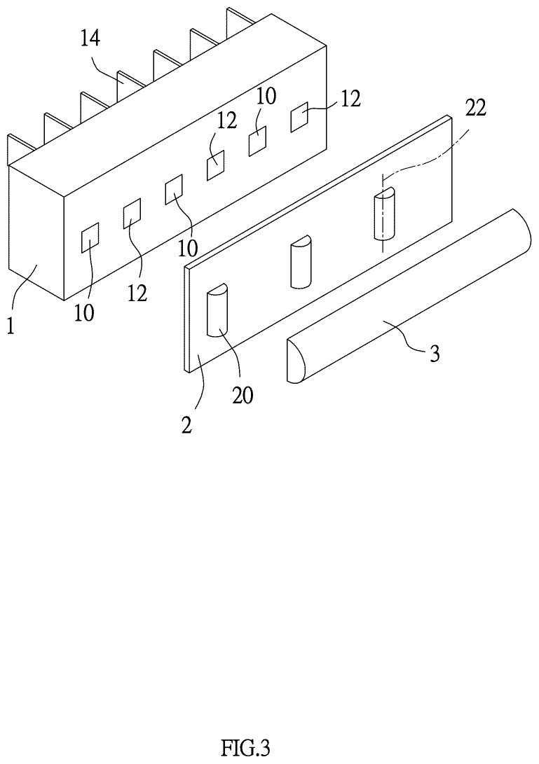

FIG. 3 illustrates a collimated lighting source for inspection according to a first exemplary embodiment of the present disclosure. In this embodiment, a base 1 has a hollow metallic housing as a heat-dissipating frame and an in-built thermally conductive substrate (unlabeled); a plurality of first solid-state lighting assemblies 10 and second solid-state lighting assemblies 12 are arranged in a single row on the thermally conductive substrate, the first solid-state lighting assemblies 10 and the second solid-state lighting assemblies 12 being alternately arranged along a horizontal direction of the figure, and heat sinks 14 as heat dissipation fins are exemplarily arranged on a rear side of the base 1; in this way, the heat generated by the first solid-state lighting assemblies 10 and the second solid-state lighting assemblies 12 can be transferred to the heat dissipation fins.

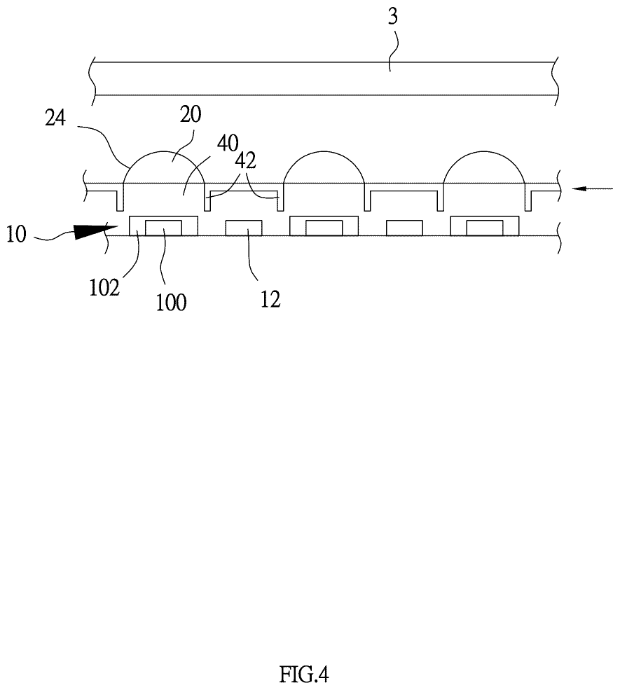

For the convenience of illustration, the first solid-state lighting assemblies 10 in this embodiment are exemplified by three white-light LEDs. Referring also to FIG. 4, each first solid-state lighting assembly 10 comprises a first unit cell 100 emitting, for example, blue light, and a fluorescent portion 102 illuminated by the blue light from the first unit cell to emit, for example, yellow light; the second solid-state lighting assemblies 12 in this embodiment are exemplified by three ultraviolet (UV)-light LEDs; the UV light has a short wavelength and a high frequency, which, once striking the fluorescent portion 102 of the first solid-state lighting assembly 10, also excites yellow light, interfering with the weak light beams diffusely reflected by a defect or dust on an inspection surface when illuminated by the UV light; therefore, when the second solid-state lighting assemblies 12 are activated, it is necessary to mask the UV light from entering the fluorescent portions or mask the light outputted from the illuminated fluorescent portions.

A row of semi-cylindrical lenses 20 are horizontally disposed in front of the first solid-state lighting assemblies 10 and the second solid-state lighting assemblies 12 along the single row. In this embodiment, three semi-cylindrical lenses 20 are configured, and the major axis 22 of each semi-cylindrical lens 20 extends in the longitudinal direction as shown in the figure. Therefore, when viewed from the top to the bottom as shown in FIG. 4, the cylindrical, unidirectional, collimated refractive outer edge 24 of each semi-cylindrical lens 20 can be seen, i.e., the light beams emitted by the rear solid-state lighting assemblies, after passing through the semi-cylindrical lenses 20, are collimated and output upward from the bottom as shown in FIG. 4, forming a uniform light distribution along the horizontal direction of the base 1. One semi-cylindrical elongated lens 3 is further arranged in front of the semi-cylindrical lens 20, the semi-cylindrical elongated lens 3 being mounted on the base 1 with its optical axis perpendicular to the direction of the major axis 22 of each semi-cylindrical lens 20, allowing for the light beams transmitted through the semi-cylindrical lenses 20 to be outputted also as a collimated uniform light beam along the longitudinal direction of the base 1. Thus, the light beams emitted by each first solid-state lighting assembly 10 or second solid-state lighting assembly 12, after passing through the semi-cylindrical lens 20 and semi-cylindrical elongated lens 3 crossed with each other, are outputted as a uniform square or rectangular light beam, so that the inspection surface of the inspection wafer, component, or equipment is all uniformly illuminated, and any automated optical capture device may obtain a uniform background, facilitating identification and recording of defects or dust using the light diffusively reflected thereby.

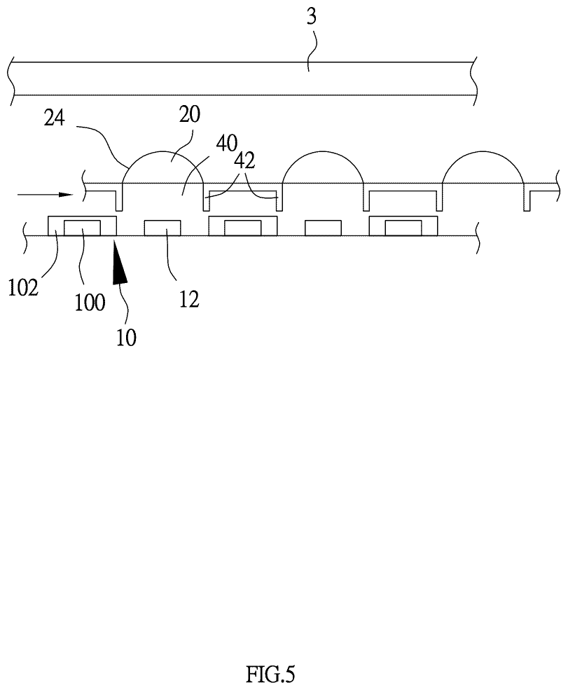

In this embodiment, the three semi-cylindrical lenses 20 are located at positions of three light-passing through-holes 40 on an actuator 2, respectively, while the photomask 4 comprises a plurality of mask sheets 42 mounted on a back surface of the actuator 2, the mask sheets 42 surrounding the light-passing through-holes 40 corresponding thereto. Thus, as shown in FIGS. 4 and 5, when the UV light emitted by the second solid-state lighting assemblies 12 is used as the inspection light, the mask sheets 42 mask the front and side edges of the first solid-state lighting assemblies 10; this prevents any UV light from being incident on the fluorescent portions 102 of the first solid-state lighting assemblies 10, thus preventing generation of yellow light. The second solid-state lighting assemblies 12 are aligned with the light-passing through-holes 40 and the semi-cylindrical lenses 20, such that the UV light beams are collimated by the corresponding semi-cylindrical lenses 20 and semi-cylindrical elongated lens 3 into a single horizontal inspection beam jointly combined by three square uniform light beams. This configuration is particularly suitable for inspecting substances with fluorescent reactions, such as bloodstains or fluorescent proteins.

Correspondingly, when the first solid-state lighting assemblies 10 are activated to illuminate a same inspection range with white light, the mask sheets 42 mask the front and side edges of the second solid-state lighting assemblies 12, and after the first solid-state lighting assemblies 10 are exposed to the light-passing through-holes 40, they are directly aligned to the positions of the semi-cylindrical lens 20; consequently, the white light beams are collimated by the corresponding semi-cylindrical lens 20 and semi-cylindrical elongated lens 3 into a single horizontal inspection beam combined by three square uniform light beams.

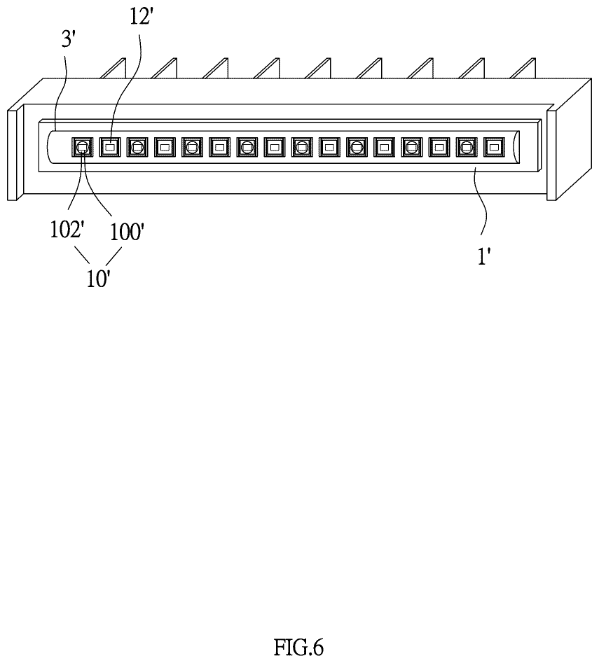

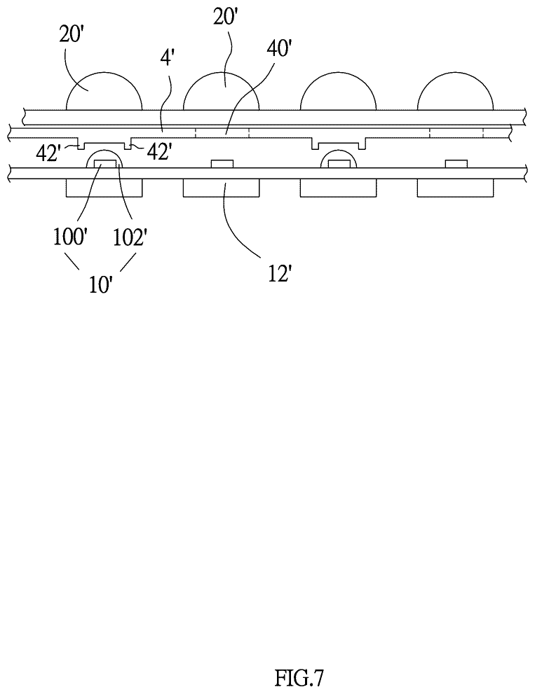

Of course, as will be readily understood by those skilled in the art, the present disclosure is not limited to the wavelengths of the solid-state lighting assemblies described above, and the structure of the mask sheets is not necessarily integrated with the semi-cylindrical lenses. FIGS. 6 and 7 illustrate a second exemplary embodiment of the present disclosure, where the first solid-state lighting assemblies 10′ are exemplified by fluorescent and electroluminescent dies made of, for example, a quantum dot nanocomposite luminescent material, equipped with organic light-emitting semiconductors emitting, for example, green light, as the second solid-state lighting assemblies 12′; the semi-cylindrical lenses 20′ are disposed in front of each of the first solid-state lighting assemblies 10′ and each of the second solid-state lighting assemblies 12′, respectively, while a semi-cylindrical elongated lens 3′ is further disposed in front of the semi-cylindrical lenses 20′. A photomask 4′, e.g., a baffle plate (unlabeled), is disposed in front of the first solid-state lighting assemblies 10′ and the second solid-state lighting assemblies 12′ and rear to the semi-cylindrical lenses 20′, the photomask 4′ being provided with light-passing through-holes 40′, counts of the light-passing through-holes being half of the counts of the semi-cylindrical lenses 20′; therefore, only the photomask 4′ moves left and right relative to the base 1′. When activating the first solid-state lighting assemblies 10′, the light-passing through-holes 40′ of the photomask 4′ are aligned to the first solid-state lighting assemblies 10′, so that the mask sheets 42′ mask the second solid-state lighting assemblies 12′ and expose the first solid-state lighting assemblies 10′; conversely, when activating the second solid-state lighting assemblies 12′, the photomask 4′ is moved to mask the first solid-state lighting assemblies 10′, ensuring that the first unit cell 100′ and the fluorescent portions 102′ are not illuminated and thus do not emit fluorescent light to cause interference. When the lighting source for inspection is required to emit light of more different colors, further third and fourth solid-state lighting assemblies may be arranged in the horizontal row on the thermally conductive substrate, provided that the photomask can flexibly mask the idle lighting assemblies and expose the selected lighting assemblies each time; or, a second row in addition to the first row may be arranged in the longitudinal direction; all of the above do not go beyond the architecture of the present disclosure; instead, they can offer greater flexibility in application.

In view of the above, the collimated lighting source for inspection has an overall simple structure, where two or even more different lighting sources can be selected. In particular, by using extruded or drawn semi-cylindrical lenses and semi-cylindrical elongated lenses, the present disclosure not only reduces the manufacturing cost, but also enables adjustment of the focal length as per the mold. Provided that the lenses are arranged substantially perpendicular to each other in the longitudinal and horizontal directions, the output light beam of each independent lighting assembly can be shaped into a uniform square or rectangular collimated light pattern, forming a uniform collimated lighting source that meets the requirements of low-angle light emission for inspection.

What have been described are only exemplary embodiments of the disclosure, which are not intended for limiting the scope of the disclosure; any simple equivalent variations and modifications to the claimed scope and the content of the specification of the disclosure shall fall within the scope of the disclosure.

I/We claim:

1. A collimated lighting source for inspection, comprising:
a base;
a plurality of first solid-state lighting assemblies and a plurality of second solid-state lighting assemblies, the plurality of first solid-state lighting assemblies and the plurality of second solid-state lighting assemblies being alternatively arranged in a single row on the base, wherein the first solid-state lighting assemblies each comprise at least one first unit cell and one fluorescent portion illuminated by a light beam emitted by the first unit cell to emit fluorescence;
a column of semi-cylindrical lenses arranged along the single row, counts of the semi-cylindrical lenses corresponding to total counts of the first and second solid-state light emitting modules, each of the semi-cylindrical lenses having a cylindrical, unidirectionally collimating, light-refracting outer edge extending along a major axis, the major axis being oriented perpendicular to the single row;
a semi-cylindrical elongated lens disposed on the base and oriented perpendicular to the major axis of each of the semi-cylindrical lenses;
at least one photomask configured to: when the second solid-state lighting assemblies are enabled to emit light beams, mask the light beams from entering the fluorescent portions of the first solid-state lighting assemblies, and when the first solid-state lighting assemblies are enabled to emit light beams, expose the first solid-state lighting assemblies.

2. The collimated lighting source for inspection according to claim 1, wherein the base further comprises at least one heat sink thermally conductively connected to the first solid-state lighting assemblies and the second solid-state lighting assemblies.

3. The collimated lighting source for inspection according to claim 2, wherein counts of the semi-cylindrical lenses is equal to total counts of the first solid-state lighting assemblies and the second solid-state lighting assemblies, such that one semi-cylindrical lens is correspondingly arranged before each of the first solid-state lighting assemblies and each of the second solid-state lighting assemblies, respectively.

4. The collimated lighting source for inspection according to claim 2, wherein each of the semi-cylindrical lenses corresponds to one of the first solid-state lighting assemblies and one of the second solid-state lighting assemblies, respectively.

5. The collimated lighting source for inspection according to claim 1, wherein the photomask is a baffle plate provided with a plurality of light-passing through holes, the photomask being configured to be movable in a direction perpendicular to the major axis between positions selected respectively for masking the first solid-state lighting assemblies and masking the second solid-state lighting assemblies.

6. The collimated lighting source for inspection according to claim 5, wherein the baffle plate further comprises a plurality of mask sheets corresponding to the plurality of light-passing through holes, respectively.

7. The collimated lighting source for inspection according to claim 1, wherein the photomask is a baffle plate provided with a plurality of mask sheets.
